(19) United States
(12) Patent Application Publication
(10) Pub. No.: US 2008/0059154 A1
(43) Pub. Date: Mar. 6, 2008

(54) Encoding an audio signal

(75) Inventors: Anssi Ramo, Tampere (FI); Lasse Laaksonen, Nokia (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/515,499

(22) Filed: Sep. 1, 2006

(51) Int. Cl. G10L 19/00

(52) U.S. Cl. 704/200.1

(57) ABSTRACT

For taking account of different requirements on encoded audio data having different bit rates, at least two different amounts of pre-processing are applied to an audio signal to obtain at least two different target signals. A first one of the target signals is then encoded to obtain primary coded data. At least a second one of the at least two different target signals is moreover used for generating enhancement data for the primary coded data.

### FIELD OF THE INVENTION

The invention relates to encoding of audio signals. It relates more specifically to a method, an apparatus, a device, a system and a computer program product supporting such an encoding.

### BACKGROUND OF THE INVENTION

When encoding audio signals, like speech signals, noise suppression may be used in some cases as a processing step preceding the actual encoding in order to improve the sound quality.

Especially lower bit rates may require noise suppression in order to obtain a reasonably good sound in a noisy environment.

Higher bit rates, in contrast, may result in a high audio quality without any pre-processing. In the case of music signals, noise suppression may even add additional distortions to the signal.

Speech encoders and decoders (codecs) are usually optimized for speech signals, and quite often, they operate with a fixed bit rate.

However, an audio codec could also be configured to operate with varying bit rates. At the lowest bit rates, such an audio codec should work as well as a pure speech codec at similar rates. At the highest bit rates, the performance should be good with any signal, including music and background noises, which may be considered as audio signals. In order to achieve these goals, more noise suppression may be used in low bit rate speech encoding, while no noise suppression may be used in higher bit rate audio/speech encoding.

A further audio coding option is an embedded variable rate speech coding, which is also referred to as a layered coding. Embedded variable rate speech coding denotes a speech coding, in which a bit stream is produced, which comprises primary coded data generated by a core encoder and additional enhancement data, which refines the primary coded data generated by the core encoder. A subset or subsets of the bit stream can then be decoded with good quality. ITU-T standardization aims at a wideband codec of 50 to 7000 Hz with bit rates from 8 to 32 kbps. The codec core will work with 8 kbps and additional layers with quite small granularity will increase the observed speech and audio quality. Minimum target is to have at least five bit rates of 8, 12, 16, 24 and 32 kbps available from the same embedded bit stream.

### SUMMARY

When using embedded variable rate speech coding, it is a problem that low bit rate encoding and high bit rate encoding are used in the same coder for producing a single bit stream, while different bit rates have different requirements on the noise suppression. When simply omitting the noise suppression, some low bit rate quality is lost. When simply using a high amount of noise suppression, distortion may be introduced to some types of audio signals. A similar problem may occur with any sequential audio coding approach and equally with other kinds of pre-processing.

A method is proposed, which comprises applying at least two different amounts of pre-processing to an audio signal to obtain at least two different target signals. The method further comprises encoding a first one of the target signals to obtain primary coded data. The method further comprises using at least a second one of the at least two different target signals for generating enhancement data for the primary coded data.

It is to be understood that the order of the processing in the proposed method is not fixed. The second target signal could be generated for example before, after or in parallel to the encoding of the first target signal.

Moreover, an apparatus is proposed, which comprises a pre-processing component configured to apply at least one of at least two different amounts of pre-processing to an audio signal to obtain at least two different target signals. The apparatus further comprises a core encoder component configured to encode a first one of the at least two different target signals to obtain primary coded data. The apparatus further comprises at least one enhancement layer encoder component configured to use at least a second one of the at least two different target signals for generating enhancement data for primary coded data provided by the core encoder component.

The apparatus could be for example an audio coder or an entity comprising an audio coder.

It is to be noted that the pre-processing component, the core encoder component and the at least one enhancement layer encoder component can be implemented in hardware and/or in software. If implemented in hardware, the apparatus could be for instance a chip or chipset, like an integrated circuit. If implemented in software, the components could be modules of a software program code. In this case, the apparatus could be for instance a memory storing the software program code.

Moreover, a device is proposed, which comprises the proposed apparatus and in addition a user interface.

Moreover, a system is proposed, which comprises the proposed apparatus and a further apparatus including a decoder configured to decode primary coded data and enhancement data generated by the proposed apparatus. The primary coded data may be decoded by itself to regain an audio signal, while any additional enhancement data allows generating an audio signal with a further improved quality.

Finally, a computer program product is proposed, in which a program code is stored in a computer readable medium. The program code realizes the proposed method when executed by a processor.

The computer program product could be for example a separate memory device, or a memory that is to be integrated in an electronic device.

The invention is to be understood to cover such a computer program code also independently from a computer program product and a computer readable medium.

A target signal is the signal which is attempted to be reached in each coding layer, that is, either in the core coding or in a respective enhancement layer coding, with a respectively assigned bit budget. The invention proceeds from the idea that different coding layers of a sequential audio coding do not have to be provided necessarily with the same target signal. Rather, internal target signals of an encoder could be adjusted individually for each coding layer. It is therefore proposed that different target signals, resulting from different amounts of pre-processing applied to an audio signal, are provided to different successive coding layers.

This approach allows using an optimal amount of pre-processing for each of at least two successive coding layers. As a result, the perceived quality of an audio signal that is obtained when decoding the primary coded data or the primary coded data and an arbitrary amount of enhancement data is improved.

The applied pre-processing could comprise for example noise suppression, but equally another kind of pre-processing, like a perceptual filtering and modeling, etc.

The invention may be realized with little effort, since processing components like noise suppressors are often easily adjustable in the amount of pre-processing they apply anyhow.

The primary coded data and the enhancement data can be provided for example in a single bit stream, either for transmission or for any other use.

The first one of the target signals could be obtained by applying the highest amount of pre-processing of the at least two different amounts of pre-processing. The first target signal is used by the core coder for generating the primary coded data, and thus the signal with the lowest bit rate that is suited to be decoded. By using the maximum amount of pre-processing for the target signal for this primary coded data, it can be ensured that the lowest bit rate signal has a good quality for speech signals.

In an exemplary embodiment, a plurality of target signals are used in sequence for generating enhancement data for the entirety of the primary coded data and any precedingly generated enhancement data. By way of example, at least four target signals could be used in sequence for generating enhancement data. Together with the target signal that is used for generating the primary coded data, this allows achieving five bit rates of, for example, 8, 12, 16, 24 and 32 kbps. It has to be noted, though, that any other number of target signals could be used as well.

Each target signal that is used in sequence for generating enhancement data could be obtained by applying a lower amount of pre-processing to the audio signal compared to the amount of pre-processing that is applied for obtaining a target signal that is used for a preceding generation of enhancement data.

In the case of noise suppression, for example, each coding layer can work with such a graduation with the perceptually optimal amount of remaining background noise in the input so that the perceived quality can be optimal for every available bit rate.

It is to be understood that it is not required that a different target signal is employed for each coding layer. Instead, some coding layers, in particular adjacent coding layers, may also be provided with the same target signal. Especially when the granularity of the encoder components is high, partly a lower and partly an equal amount of pre-processing could be applied for obtaining a target signal compared to the amount of pre-processing that is applied for obtaining a target signal that is used for a preceding generation of enhancement data.

One of the target signals used in sequence for generating enhancement data could be obtained by applying the lowest amount of pre-processing of the at least two different amounts of pre-processing. This target signal can be used in particular for the last enhancement layer encoding.

In general, a lowest amount of pre-processing of the at least two different amounts of pre-processing applied to an audio signal could be a pre-processing of zero, but also any other amount that is lower than the maximum amount.

For an amount of pre-processing that is equal to zero, the actual pre-processing, for example by means of a noise suppression component, may simply be bypassed so that the original audio signal is made available as one of the at least two different target signals. This option is to be understood to be covered by the expression that at least two different amounts of pre-processing are applied to an audio signal to obtain at least two different target signals.

A bit stream comprising the primary coded data and the enhancement data may be truncated if needed. The truncation may be performed at an encoding end generating the bit stream, at a decoding end receiving at least a portion of the bit stream and/or on a transmission path employed for transmitting at least a portion of the bit stream from an encoding end to a decoding end.

The electronic device can be for instance a mobile terminal, but equally any other device that is to be used for encoding audio data.

The invention can be employed for example for transmissions via a packet switched network, for instance for Voice over IP (VoIP), or for transmissions via a circuit switched network, for instance in a global system for mobile communication (GSM). The invention can also be employed for transmissions via other types of networks or independently of any transmission.

It is to be understood that the features and steps of all presented embodiments can be combined in any suitable way.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of a system according to an embodiment of the invention;

FIG. 2 is a flow chart illustrating an operation in the system of FIG. 1;

FIG. 3 is a variation of the system of FIG. 1;

FIG. 4 is a schematic block diagram of a device according to an embodiment of the invention; and

FIG. 5 is a flow chart illustrating an operation in the device of FIG. 4.

### DETAILED DESCRIPTION OF THE INVENTION

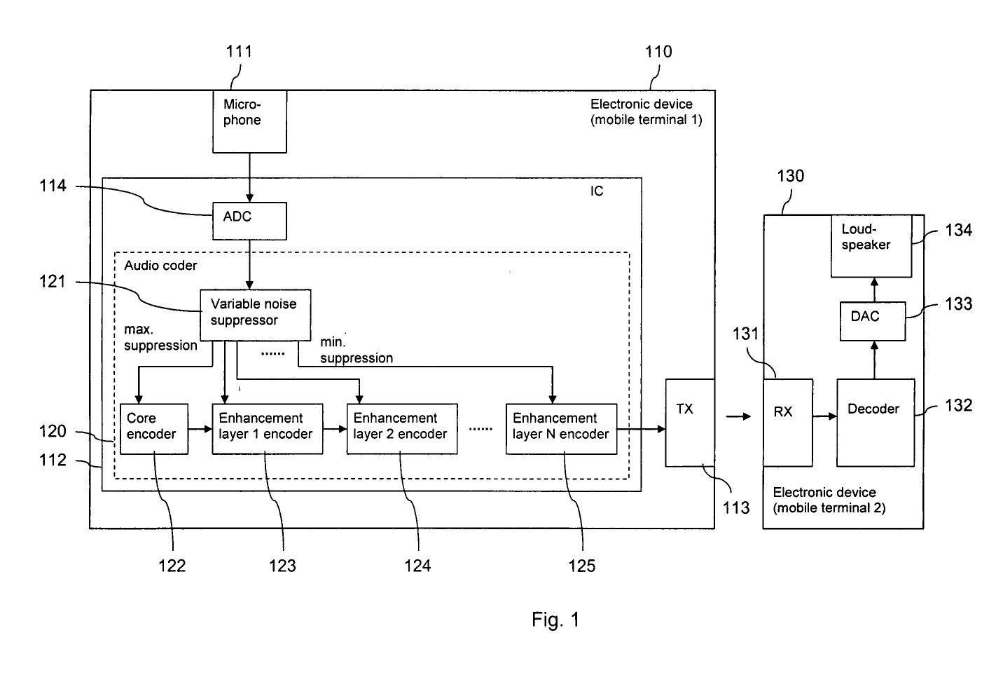

FIG. 1 is a schematic block diagram of an exemplary system, which enables adaptive noise suppression for embedded variable rate speech coding in accordance with an embodiment of the invention.

The system comprises a first electronic device 110 and a second electronic device 130. The system could be for instance a mobile communication system, in which the electronic devices 110, 130 are mobile terminals.

The first electronic device 110 comprises a microphone 111, an integrated circuit (IC) 112 and a transmitter (TX) 113. The integrated circuit 112 or the electronic device 110 could be considered as an exemplary embodiment of the apparatus according to the invention.

The integrated circuit 112 comprises an analog-to-digital converter (ADC) 114 and an audio coder portion 120. The audio coder portion 120 comprises a variable noise suppressor 121, a core encoder 122 and N enhancement layer encoders 123 to 125 for N enhancement layers, where N is an integer number. The microphone 110 is linked to the analog-to-digital converter 114. The analog-to-digital converter 114 is further linked to the variable noise suppressor 121. The variable noise suppressor 121 is moreover linked to the core encoder 122 and to enhancement layer 1 to N encoders 123 to 125. The core encoder 122, finally, is linked via the enhancement layer encoders 123 to 125, in the enhancement layer order 1 to N, to the transmitter 113.

The core encoder 122 can be chosen as desired. An exemplary candidate is an algebraic code excited linear prediction (ACELP) coder, for example an adaptive multirate wideband (AMR-WB) coder or a variable-rate multimode wideband (VWR-WB) coder. Corresponding codecs have been described for instance by Sussun Ahmadi, Milan Jelineki, Redwan Salamit and S. Craig Greer in: “Wideband Speech Coding for CDMA2000® Systems”, IEEE, 2003, and by Bruno Bessette, Redwan Salami, Roch Lefebvre, Milan Jelínek, Jani Rotola-Pukkila, Janne Vainio, Hannu Mikkola, and Kari Järvinen in “The Adaptive Multirate Wideband Speech Codec (AMR-WB)” IEEE Transactions on Speech and Audio Processing, Vol. 10, No. 8, November 2002.

Also the enhancement layer coders 123 to 125 can be selected as desired. The choice could depend on, for example, whether the purpose of enhancement layers is to maximize error resilience, to maximize output speech quality or to obtain good quality coding of music signals, etc. Examples of different technologies are described for instance by C. Erdmann, D. Bauer and P. Vary in: “Pyramid CELP: Embedded Speech Coding for Packet Communications”, IEEE 2002, and in the Draft new ITU-T Recommendation G.729.1 (ex G.729EV): “G.729 based Embedded Variable bit-rate (G.729EV) coder: An 8-32 kbit/s scalable wideband coder bitstream interoperable with G.729”.

It is to be understood that the electronic device 110 could comprise various other components not shown. The integrated circuit 112 could comprise additional components too. Further, it is to be understood that the analog-to-digital converter 114 could also be arranged external to the integrated circuit 112 and that the microphone 111 could also be realized in the form of an accessory to the electronic device 110. Moreover, it has to be noted that microphone 111, analog-to-digital converter 114, audio coder 120 and transmitter 113 could also be connected to each other via one or more other components of the first electronic device 110.

The second electronic device 130 comprises, linked to each other in this order, a receiver (RX) 131, a decoder 132, a digital-to-analog converter 133 and loudspeakers 134.

It is to be understood that also the electronic device 130 could comprise various other components not shown, and that the loudspeakers 134 could also be realized in the form of an accessory device. Further, it has to be noted that receiver 131, decoder 132, digital-to-analog converter 133 and loudspeakers 134 could also be connected to each other via one or more other components of the electronic device 130.

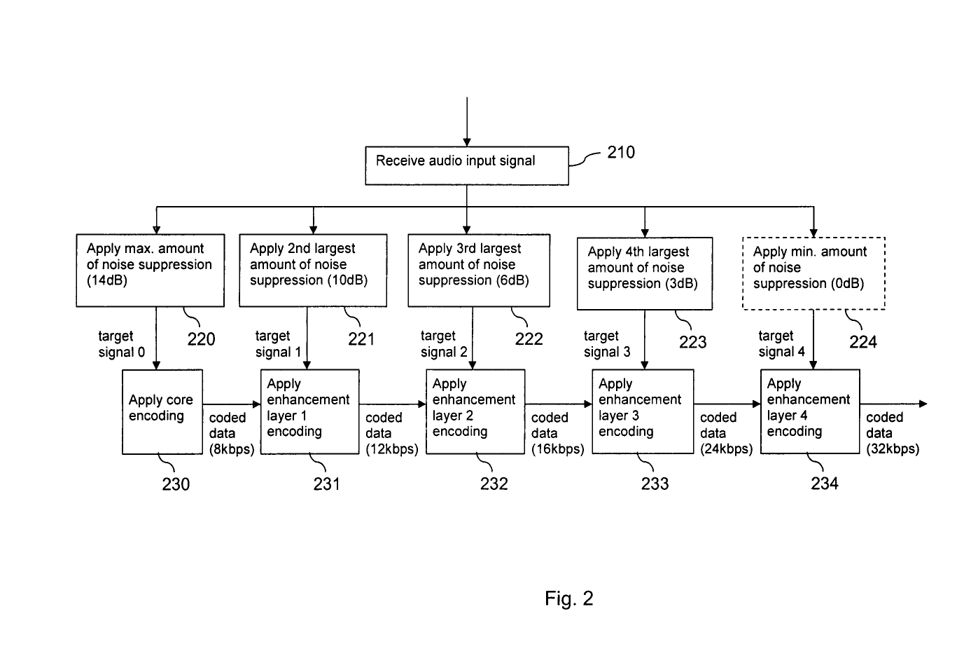

An exemplary operation according to the invention in the system of FIG. 1 will now be described with reference to FIG. 2. FIG. 2 is a flow chart illustrating the processing within the audio coder 120. The number of enhancement layers N is assumed equal to four.

A user of the first electronic device 110 may use the microphone 111 for inputting audio data that is to be transmitted to the second electronic device 130 via a mobile communication network.

The analog-to-digital converter 114 converts the analog audio signal received via the microphone 111 into a digital audio signal.

The audio coder receives the digital audio signal from the analog-to-digital converter 114 (step 210).

Within the audio coder 120, the received audio signal is provided to the variable noise suppressor 121

The variable noise suppressor 121 applies in parallel five different amounts of noise suppression to the received audio signal, reaching from a maximum amount to a minimum amount. One exemplary approach for applying a respective amount of noise suppression to the audio signal is to track the input signal energy level, to calculate the noise estimates for critical bands—and/or similar frequency bins—of the input signal, and then to scale the input signal levels accordingly in the spectral domain.

The maximum amount of applied noise suppression could be for example 14 dB (step 220). The resulting first target signal 0 is provided to the core encoder 122.

The second largest amount of applied noise suppression could be for example 10 dB (step 221). The resulting second target signal 1 is provided to the enhancement layer 1 encoder 123.

The third largest amount of applied noise suppression could be for example 6 dB (step 222). The resulting third target signal 2 is provided to the enhancement layer 2 encoder 124.

The fourth largest amount of applied noise suppression could be for example 3 dB (step 223). The resulting fourth target signal 3 is provided to the enhancement layer 3 encoder.

The minimum amount of applied noise suppression could be for example equal to zero (step 224). The resulting fourth target signal 4 is provided to the enhancement layer 4 encoder.

It is to be understood that suitable amounts of applied noise suppression depend on many aspects, like the application for which the encoding is performed and signal noise characteristics, and may thus be set to different values as well.

The core encoder 122 receives target signal 0, encodes this target signal 0 for example with a bit rate of 8 kbps, and provides the resulting primary coded data to the first enhancement layer 1 encoder 123 (step 230).

The first enhancement layer 1 encoder 123 receives the primary coded data and target signal 1. It uses target signal 1 for generating enhancement data for the primary coded data with an additional bit rate of 4 kbps (step 231). The primary coded data and the first enhancement layer data thus add up to enhanced coded data having a bit rate of 12 kbps.

The second enhancement layer 2 encoder 124 receives the enhanced coded data and the first enhancement layer data as enhanced coded data and in addition target signal 2. It uses target signal 2 for generating further enhancement data for the enhanced coded data with an additional bit rate of 4 kbps (step 232). The primary coded data, the first enhancement layer data and the second enhancement layer data thus add up to enhanced coded data having a bit rate of 16 kbps.

The third enhancement layer 3 encoder receives the primary coded data, the first enhancement layer data and the second enhancement layer data as enhanced coded data and in addition target signal 3. It uses target signal 3 for generating further enhancement data for the enhanced coded data with an additional bit rate of 8 kbps (step 233). The primary coded data and the first, second and third enhancement layer data thus add up to enhanced coded data having a bit rate of 24 kbps.

The fourth enhancement layer 4 encoder receives the primary coded data, the first enhancement layer data, the second enhancement layer data and the third enhancement layer data as enhanced coded data, and in addition target signal 4. The latter may correspond to the original digital audio data. The fourth enhancement layer 4 encoder uses the target signal 4 for generating further enhancement data for the enhanced coded data with an additional bit rate of 8 kbps (step 234). The primary coded data and the first, second, third and fourth enhancement layer data thus add up to enhanced coded data having a bit rate of 32 kbps.

The primary coded data and the first, second, third and fourth enhancement layer data are provided as a single embedded bit stream to the transmitter 113, which transmits the embedded bit stream via the mobile communication network to the second electronic device 130. The receiver 131 of the second electronic device 130 receives the embedded bit stream and provides it to the decoder 132. The decoder 132 decodes a subset of the embedded bit stream to regain digital audio data. The decoder 132 may use to this end the primary coded data at a bit rate of 8 kbps. Alternatively, it could use in addition the first enhancement layer data and thus a total bit rate of 12 kbps. Further alternatively, the decoder 132 could use the primary coded data and the first and second enhancement layer data and thus a total bit rate of 16 kbps. Further alternatively, the decoder 132 could use the primary coded data and the first, second and third enhancement layer data and thus a total bit rate of 24 kbps. Finally, the decoder 132 could use the primary coded data and the first, second, third and fourth enhancement layer data and thus a total bit rate of 32 kbps.

The decoded digital audio data is provided to the digital-to-analog converter 133, which converts the digital audio data into analog audio data. The analog audio data may then be presented to a user via the loudspeakers 134.

The presented embodiment of the invention thus allows using an optimal amount of noise suppression and thus an optimal target signal at the input of each coder 122 to 125. If pure speech is to be presented, a decoding of a minimum amount of data is sufficient. Due to the high applied noise suppression, the resulting speech signal has nevertheless a high quality. If mixed audio and speech is to be presented with a high quality, a maximum amount of data is required. Since the data of the last enhancement layer is based on the original digital audio data without any applied noise suppression, distortions of music components in the audio signal are prevented.

It is to be understood that the decoding by decoder 132 does not have to depend on the signal itself, that is, on whether it is a pure speech signal or an audio signal. Thus, a speech signal can be decoded with the highest quality and on the other hand, an audio signal can be decoded with the lowest quality. In embedded coding, if there is no application, terminal hardware or other constraint, the decoder generally uses the highest bit rate available to maximize the output quality. Embedded coding makes is possible, though, to truncate the bit stream by removing some parts of lesser importance whenever needed and to allow smooth degradation of the output quality, for example in the case of music signals, or to even maintain the quality very high, for example in the case of narrowband or wideband speech signals.

Thus, in embedded coding it is not required that the decoder end always receives or uses the entire bit stream, the decoder is rather able to decode a reduced bit stream as well.

A truncation of the original bit stream can be carried out already at the encoding device 110. In this case, only a truncated bit stream is transmitted, if the encoding device 110 cannot send the highest rate for some reason.

Alternatively, the bit stream can be truncated at the decoding device 130. In this case, only a part of the received bit stream is decoded. One reason for such a truncation at the decoding device 130 could be for example power saving issues in a mobile device. Moreover, a user of a decoding device 130 could be enabled to select a decoding bit rate, for example for the case that the user wishes to store a received audio signal with a low quality to save memory.

Further alternatively, a bit stream truncation can be carried out on a transmission path between the encoding device 110 and the decoding device 130, that is, in the network. For example, there might be a transcoder on the transmission path, and the bit stream could be truncated as a part of a transcoding carried out by this transcoder.

There could also be congestion or some other transmission bandwidth constraint on the transmission path, which causes the encoding device 110 or a component on the transmission path to remove a part of the original bit stream.

The presented embodiment optimizes the output quality for each of these truncated bit streams by providing a best-case target signal—in terms of noise characteristics—for each encoding layer.

The functions illustrated by the variable noise suppressor 121 can also be viewed as means for applying at least two different amounts of pre-processing to an audio signal to obtain at least two different target signals. The functions illustrated by the core encoder 122 can also be viewed as means for encoding a first one of at least two different target signals to obtain primary coded data. The functions illustrated by the enhancement layer encoders 123-125 can also be viewed as means for using at least a second one of at least two different target signals for generating enhancement data for primary coded data.

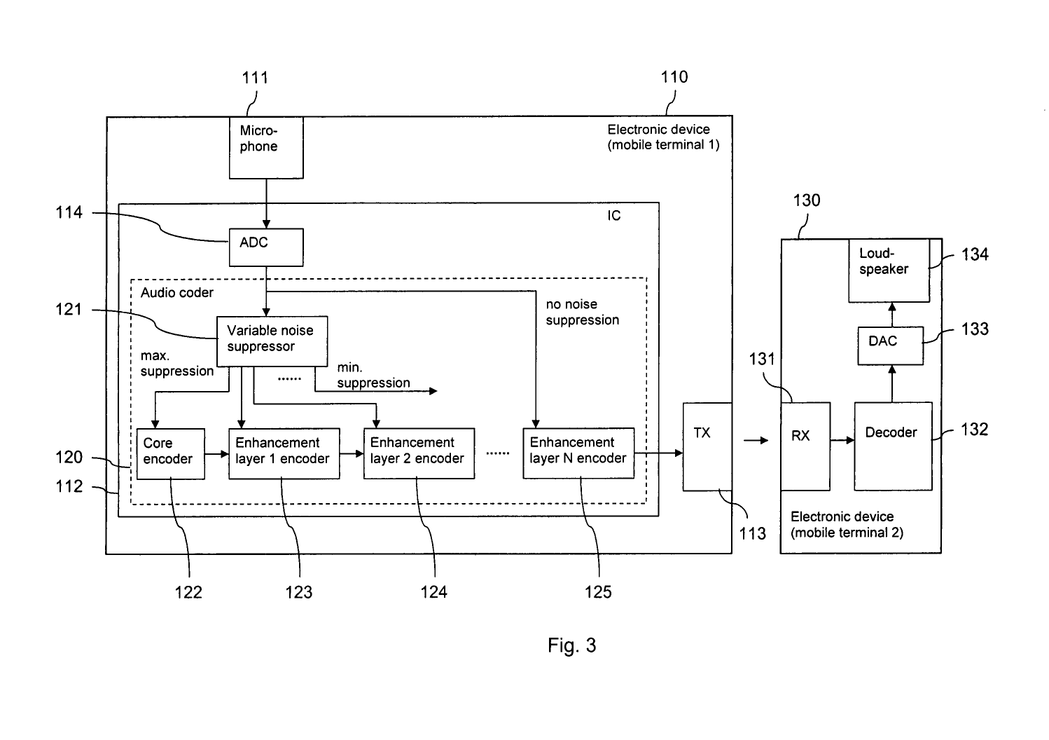

FIG. 3 is a schematic block diagram of a variation of the system of FIG. 1. All depicted components are the same and have thus been provided with the same reference signals. Only the connections between some of the components are slightly different.

More specifically, the analog-to-digital converter 114 is not only linked to the variable noise suppressor 121, but in addition to the enhancement layer N encoder 125. The variable noise suppressor 121 is only linked further to the core encoder 122 and to enhancement layer 1 to N-1 encoders 123, 124, not to enhancement layer N encoder 125.

An exemplary operation according to the invention in the system of FIG. 3 may be similar as described with reference to FIG. 2, and only differences will be pointed out in the following.

The audio coder 120 receives again the digital audio signal from the analog-to-digital converter 114. In the system of FIG. 3, however, the received audio signal is provided on the one hand to the variable noise suppressor 121 and on the other hand directly to the enhancement layer 4 encoder 125. This is taken into account in FIG. 2 by illustrating step 224 with dashed lines.

The variable noise suppressor 121 applies in parallel four different amounts of noise suppression to the received audio signal, reaching from a maximum amount to a minimum amount. The minimum amount is an amount larger than zero. The core encoder 122 and the enhancement layer encoders 123-124 process the resulting target signals 0 to 3 as described with reference to steps 230 to 233 of FIG. 2.

The fourth enhancement layer 4 encoder receives the primary coded data, the first enhancement layer data, the second enhancement layer data and the third enhancement layer data as enhanced coded data, and in addition the original digital audio data as target signal 4. For target signal 4, thus no noise suppression has been applied to the original digital audio data. The application of no noise suppression is to be understood to correspond to the application of a noise suppression of zero.

The fourth enhancement layer 4 encoder uses the target signal 4 again for generating further enhancement data for the enhanced coded data, resulting in enhanced coded data having a bit rate of 32 kbps.

The embodiment of FIG. 3 thus simply takes account of the consideration that a signal to which a lowest noise suppression of zero is to be applied does not necessarily have to pass the noise suppressor 121 in the first place.

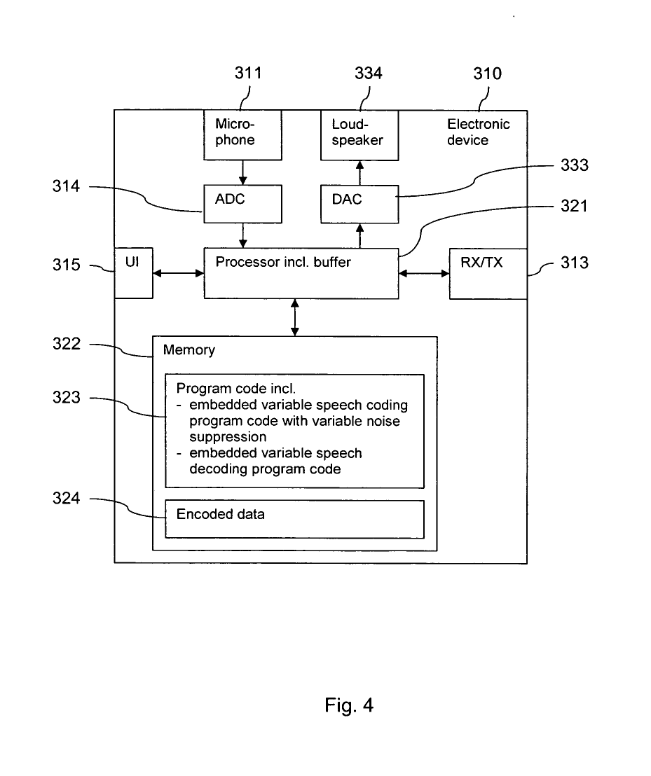

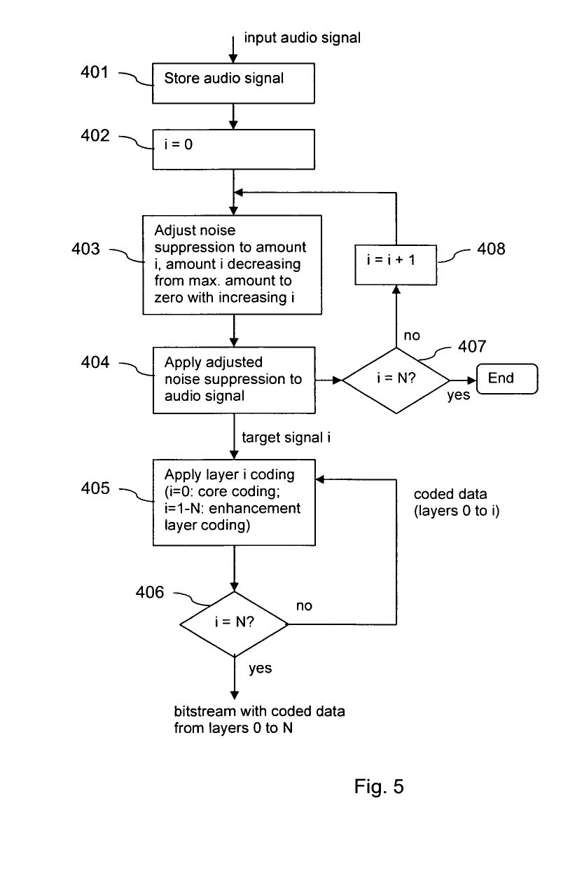

It is to be understood that the embodiments presented with reference to FIGS. 1 to 3 can be varied in many ways. For instance, one or both of the electronic devices 110, 130 could be another device than a mobile terminal. One of the electronic devices could be, by way of example, a personal computer, etc. Further, the functions of the integrated circuit 120 could also be realized by discrete components or by software, the different amounts of noise suppression could also be applied in sequence, another kind of variable pre-processing could be applied instead of the variable noise suppression, etc. A few variations will be presented in the following with reference to FIGS. 4 and 5.

FIG. 4 is a schematic block diagram of an exemplary electronic device 310, which enables adaptive noise suppression for embedded variable speech coding in accordance with a second embodiment of the invention.

The electronic device 310 could be again for example a mobile terminal of a wireless communication system. The electronic device 310 could be considered as an exemplary embodiment of the apparatus according to the invention.

It comprises a microphone 311, which is linked via an analog-to-digital converter 314 to a processor 321. The processor 321 is further linked via a digital-to-analog converter 333 to loudspeakers 334. The processor 321 is further linked to a transceiver (TX/RX) 313, to a user interface (UI) 315 and to a memory 322.

The processor 321 is configured to execute various program codes. The implemented program codes comprise an embedded variable speech coding program code with variable noise suppression and an embedded variable speech decoding program code. The implemented program codes 323 may be stored for example in the memory 322 for retrieval by the processor 321 whenever needed. The memory 322 could further provide a section 324 for storing data, for example data that has been encoded in accordance with the invention.

The user interface 315 enables the user to input commands to the electronic device 310, for example via a keypad, and/or to obtain information from the electronic device 310, for example via a display. The transceiver 313 enables a communication with other electronic devices, for example via a wireless communication network.

It is to be understood again that the structure of the electronic device 310 could be supplemented and varied in many ways.

An operation according to the invention in the electronic device 310 of FIG. 4 will now be described with reference to FIG. 5. FIG. 5 is a flow chart illustrating the operation of the processor 321 when executing the embedded variable rate speech coding program code.

A user of the electronic device 310 may use the microphone 311 for inputting audio data that is to be transmitted to some other electronic device or to be stored in the data section 324 of the memory 322. A corresponding application has been activated to this end by the user via the user interface 315. This application, which may be run by the processor 321, causes the processor 321 to execute the embedded variable speech coding program code stored in the memory 322.

The analog-to-digital converter 314 converts the input analog audio signal into a digital audio signal and provides the digital audio signal to the processor 321.

The processor 321 stores the digital audio signal in an internal buffer (step 401) and sets an index variable i to “0” (step 402).

The processor 321 then adjusts a noise suppression to an amount i, with i=0 (step 403). The amount i is defined to decrease from a maximum amount, of for example 14 dB, to a minimum amount, of for example zero dB, with an increasing i. While the index variable i is set to “0”, the amount i of the noise suppression is thus set to the maximum value.

The adjusted noise suppression is then applied to the stored audio signal to obtain a first target signal i, with i=0 (step 404).

A layer 0 coding, that is, a core coding, is applied to the target signal 0 resulting in coded data (step 405).

As long as i has not yet reached a number N (step 406), which defines the number of available enhancement layers, the coded data is provided for an enhancement coding in the next layer i+1. N may be equal to four, but it could also be any other integer number.

In addition, the index variable i is incremented (step 408), as long as i has not yet reached N (step 407).

Based on the respective new index variable i, the processor 321 continues adjusting the noise suppression to amount i (step 403), to apply the adjusted noise suppression to the stored audio signal to obtain a target signal i (step 404), and to apply a layer i coding to target signal i, taking into account the coded data that resulted in the preceding layers 0 to i−1 (step 405).

When index variable i has reached N (step 406), the enhanced coded data, including the primary coded data resulting in the core coding and the enhancement layer data for layers 1 to N, are provided as an embedded bit stream to the transceiver 313 for transmission to another electronic device. Alternatively, the enhanced coded data could be stored in the data section 324 of the memory 322, for instance for a later transmission or for a later presentation by the same electronic device 310.

It is to be understood that it would also be possible to generate first all required target signals i, and to use the target signals in the layered encoding once all target signals are available.

The electronic device 310 could also receive an embedded bit stream with correspondingly enhanced coded data from another electronic device via its transceiver 313. In this case, the processor 321 may execute the embedded variable speech decoding program code stored in the memory 322. The processor 321 decodes a suitable subset of the data in the embedded bit stream and provides the decoded data to the digital-to-analog converter 333. The digital-to-analog converter 333 converts the digital decoded data into analog audio data and outputs them via the loudspeakers 334. Execution of the embedded variable speech decoding program code could be triggered as well by an application that has been called by the user via the user interface 315.

The received enhanced coded data could also be stored instead of an immediate presentation via the loudspeakers 334 in the data section 324 of the memory 322, for instance for enabling a later presentation or a forwarding to still another electronic device.

Modules of the embedded variable rate speech coding program code can also be viewed as means for applying at least two different amounts of noise suppression to an audio signal to obtain at least two different target signals, means for encoding a first one of at least two different target signals to obtain primary coded data, and means for using at least a second one of at least two different target signals for generating enhancement data for primary coded data.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

What is claimed is:

1. A method comprising:
applying at least two different amounts of pre-processing to an audio signal to obtain at least two different target signals;
encoding a first one of said target signals to obtain primary coded data; and
using at least a second one of said at least two different target signals for generating enhancement data for said primary coded data.

2. The method according to claim 1, wherein said pre-processing comprises noise suppression.

3. The method according to claim 1, wherein said primary coded data and said enhancement data are provided in a single bit stream.

4. The method according to claim 3, wherein said bit stream is truncated, if needed, at least one of
at an encoding end generating said bit stream;
at a decoding end receiving at least a portion of said bit stream; and
on a transmission path employed for transmitting at least a portion of said bit stream from an encoding end to a decoding end.

5. The method according to claim 1, wherein said first one of said target signals is obtained by applying a highest amount of pre-processing of said at least two different amounts of pre-processing.

6. The method according to claim 1, wherein said using of at least a second one of said at least two different target signals for generating enhancement data for said primary coded data comprises using a plurality of target signals in sequence for generating enhancement data for the entirety of said primary coded data and any precedingly generated enhancement data.

7. The method according to claim 6, wherein at least four different target signals are used in sequence for generating enhancement data.

8. The method according to claim 6, wherein a last one of said target signals used in sequence for generating enhancement data is obtained by applying the lowest amount of pre-processing of said at least two different amounts of pre-processing to said audio signal.

9. The method according to claim 6, wherein each target signal used in sequence for generating enhancement data is obtained by applying a lower or equal amount of pre-processing compared to the amount of pre-processing that is applied for obtaining a target signal that is used for a preceding generation of enhancement data or for a preceding generation of primary coded data, respectively.

10. The method according to claim 1, wherein a lowest amount of pre-processing of said at least two different amounts of pre-processing is a pre-processing of zero.

11. An apparatus comprising:
a pre-processing component configured to apply at least one of at least two different amounts of pre-processing to an audio signal to obtain at least two different target signals;
a core encoder component configured to encode a first one of said at least two different target signals to obtain primary coded data;
at least one enhancement layer encoder component configured to use at least a second one of said at least two different target signals for generating enhancement data for primary coded data provided by said core encoder component.

12. The apparatus according to claim 11, wherein said pre-processing component is a noise suppression component.

13. The apparatus according to claim 11, wherein said apparatus is configured to provide said primary coded data and said enhancement data in a single bit stream.

14. The apparatus according to claim 11, wherein said pre-processing component is configured to apply a highest amount of pre-processing of said at least two different amounts of pre-processing for obtaining said first one of said target signals.

15. The apparatus according to claim 11, wherein said at least one enhancement layer encoder component comprises a plurality of enhancement layer encoder components arranged in sequence, said plurality of enhancement layer encoder components being configured to use respective target signals for generating enhancement data for the entirety of said primary coded data and any precedingly generated enhancement data.

16. The apparatus according to claim 15, wherein said plurality of enhancement layer encoder components comprise at least four enhancement layer encoder components.

17. The apparatus according to claim 15, wherein a last one of said plurality of said enhancement layer encoder components is arranged to receive a target signal for generating enhancement data, which target signal has been obtained by applying the lowest amount of pre-processing of said at least two different amounts of pre-processing to said audio signal.

18. The apparatus according to claim 15, wherein said plurality of said enhancement layer encoder components are arranged to receive a respective target signal which has been obtained by applying a respective lower or equal amount of pre-processing than used for the target signal provided to a respective preceding enhancement layer encoder component or to a preceding core encoding component, respectively.

19. The apparatus according to claim 11, wherein one of said at least two different amounts of pre-processing is zero, and wherein one of said at least one enhancement layer encoder components is arranged to receive said audio signal without an applied pre-processing as a target signal.

20. The apparatus according to claim 11, wherein said apparatus is an audio coder.

21. An electronic device comprising the apparatus according to claim 11 and a user interface.

22. A system comprising the apparatus according to claim 11 and an apparatus including a decoder configured to decode primary coded data and enhancement data generated by said apparatus according to claim 11.

23. A computer program product in which a program code is stored in a computer readable medium, said program code realizing the following when executed by a processor:
applying at least two different amounts of pre-processing to an audio signal to obtain at least two different target signals;
encoding a first one of said target signals to obtain primary coded data; and
using at least a second one of said at least two different target signals for generating enhancement data for said primary coded data.

24. The computer program product according to claim 23, wherein said first one of said target signals is obtained by applying the highest amount of pre-processing of said at least two different amounts of pre-processing to said audio signal.

25. The computer program product according to claim 23, wherein said using of at least a second one of said at least two different target signals for generating enhancement data for said primary coded data comprises using a plurality of target signals in sequence for generating enhancement data for the entirety of said primary coded data and any precedingly generated enhancement data.

26. The computer program product according to claim 25, wherein each target signal used in sequence for generating enhancement data is obtained by applying a lower or equal amount of pre-processing compared to the amount of pre-processing that is applied for obtaining a target signal that is used for a preceding generation of enhancement data or for a preceding generation of primary coded data, respectively.

27. An apparatus comprising:
means for applying at least one of at least two different amounts of pre-processing to an audio signal to obtain at least two different target signals;
means for encoding a first one of said at least two different target signals to obtain primary coded data;
means for using at least a second one of said at least two different target signals for generating enhancement data for primary coded data.

28. The apparatus according to claim 27, wherein said means for applying at least one of at least two different amounts of pre-processing are means for applying at least one of at least two different amounts of noise suppression.

29. The apparatus according to claim 27, wherein said means for applying at least one of at least two different amounts of pre-processing to an audio signal are configured to apply a highest amount of pre-processing of said at least two different amounts of pre-processing to said audio signal for obtaining said first one of said target signals.

30. The apparatus according to claim 27, wherein said means for using at least a second one of said at least two different target signals for generating enhancement data are configured to use a plurality of target signals in sequence for generating enhancement data for the entirety of said primary coded data and any precedingly generated enhancement data.

31. The apparatus according to claim 30, wherein said means for using at least a second one of said at least two different target signals for generating enhancement data are configured to use a respective target signal that has been obtained by applying a lower or equal amount of pre-processing compared to the amount of pre-processing that has been applied for obtaining a target signal that is used for a preceding generation of enhancement data or for a preceding generation of primary coded data, respectively.
